(19) United States
(12) Patent Application Publication
(10) Pub. No.: US 2012/0111847 A1
(43) Pub. Date: May 10, 2012

(54) HEATING APPARATUS AND METHOD FOR TABLETOP AND MEDICAL SYSTEM THEREOF

(76) Inventors: Feng Wang, Beijing (CN); Yuqing Li, Beijing (CN); Fusheng Li, Beijing (CN)

(21) Appl. No.: 13/292,406

(22) Filed: Nov. 9, 2011

(30) Foreign Application Priority Data
Nov. 9, 2010 (CN) 201010552052.1

(51) Int. Cl. H05B 1/00

(52) U.S. Cl. 219/218

(57) ABSTRACT

A heating tabletop configured to perform ray diagnosis is provided. The heating tabletop includes a tabletop surface having at least one carbon fiber composite material layer, and a heating unit disposed at a longitudinal edge area of the tabletop surface and coupled to said at least one carbon fiber composite material layer.

### TECHNICAL FIELD

The present application relates to a heating tabletop, heating method and medical system including a heating tabletop.

### BACKGROUND OF THE INVENTION

X-ray can penetrate through materials which can not be penetrated through by ordinary visible light. The energy of a photon of visible light is small due to its longer wavelength, and when visible light is irradiated on an object, a part of the visible light is reflected and the majority is absorbed by the object, thus, the visible light cannot penetrate through the object. By contrast, the energy of the photon of X-ray is large due to its short wavelength, and when X-ray is irradiated on an object, only a small part is absorbed by the object while the majority can penetrate through atom gaps, thus X-ray exhibits strong penetrating capability. The penetrating capability of X-ray is associated with a density of a material. Materials of great density absorb a large part of X-ray, while only a small part of X-ray can penetrate through; materials of small density absorb a small part of X-ray while a large part can penetrate through. Skeleton, muscle and soft tissues such as body fat, which have different densities, can be distinguished by using this differential absorption nature of X-ray.

The current conventional ray diagnosis system generally uses the aforesaid differential absorption nature of X-ray. An X-ray diagnosis system usually comprises an X-ray transmitter and a receiver. Generally speaking, as shown in FIG. 1 and FIG. 2, a patient lies on a tabletop 100 during the diagnosis process, a transmitter (not shown) is disposed over the examined part of the patient for transmitting X-rays; a receiver (not shown) is disposed in the middle of the tabletop or under the tabletop for receiving X-rays that pass through the examined part of the patient and the tabletop.

During the X-ray diagnosis process, a patient is usually required to dress as little as possible for obtaining a clear X-ray image due to absorption of X-ray of clothes. Moreover, since X-ray diagnosis imposes particular requirement on humidity and temperature of the diagnosis room, a patient lying on a current tabletop for diagnosis will feel uncomfortable and cold.

Not only a tabletop used for X-ray diagnosis has said problem, tabletops used for other similar ray diagnosis (such as CT scanning, etc.) have a similar problem, too.

Sometimes, a doctor will put a cushion on the tabletop to enhance comfort of the patient. But a cushion is not recommended because it brings extra Object Image Distance (OID) and will affect the resulting imaging quality.

### SUMMARY OF THE INVENTION

The object of the present invention is to provide a heating tabletop for ray diagnosis, i.e. a tabletop having a heating function. A patient will not feel uncomfortable and cold when lying on the heating tabletop.

The present invention provides a heating tabletop for ray diagnosis, comprising a tabletop surface including a heating unit, said heating unit being disposed at a longitudinal edge area of the tabletop surface; said tabletop surface further comprising a carbon fiber composite material layer; wherein said heating unit is coupled to said carbon fiber composite material layer.

Optionally, said tabletop surface comprises two carbon fiber composite material layers.

Optionally, said heating unit is disposed between two carbon fiber composite material layers.

Optionally, one of the two carbon fiber composite material layers completely encloses said heating unit.

Optionally, a foam material layer and a fabroil layer are disposed between said two carbon fiber composite material layers.

Optionally, said heating unit is disposed in said fabroil layer.

Optionally, said tabletop surface further comprises two HPL layers, said two HPL layers are disposed outside said two carbon fiber composite material layers respectively.

The present invention further provides a method for heating a tabletop for ray diagnosis, said tabletop comprises a tabletop surface (102), said method comprises: arranging a heating unit (303) and a carbon fiber composite material layer (402) within the tabletop surface (102); wherein said heating unit (303) is disposed at a longitudinal edge area of the tabletop surface (102); and coupling said heating unit (303) with said carbon fiber composite material layer (402).

Optionally, said heating method may further comprise arranging an input unit (501), a temperature feedback unit (315) and a control unit (310) in said tabletop; and the control unit (310) controlling the time for heating said heating unit (303) by comparing the temperature setting of the tabletop surface provided by the input unit (501) with the actual temperature of the tabletop surface fed back by the temperature feedback unit (315).

Furthermore, the present invention provides a medical system including a heating tabletop.

The heating unit in the heating tabletop provided by the present invention is disposed at a longitudinal edge area of the tabletop surface to avoid the ray (e.g. X-ray) penetrating though the heating unit directly and impact on the imaging quality. The tabletop surface of the heating tabletop further comprises a carbon fiber composite material layer. The thermal conductivity of the carbon fiber composite material layer is close to that of water and does not absorb X-ray substantially, coupling a heating unit with a carbon fiber composite material layer makes the heat generated by the heating unit evenly distributed over the whole tabletop surface, whereby the comfort level of a patient lying on the heating tabletop can be enhanced.

### BRIEF DESCRIPTION OF THE DRAWINGS

FIG. 1 and FIG. 2 show implementations of the heating tabletop of the present invention.

FIG. 3 shows a heating tabletop according to one embodiment of the present invention.

FIG. 4 is a section view of a heating tabletop according to one embodiment of the present invention taken along the A-A′ direction in FIG. 3.

FIG. 5 shows a heating tabletop having temperature loop control according to one embodiment of the present invention.

### BEST MODES FOR CARRYING OUT THE INVENTION

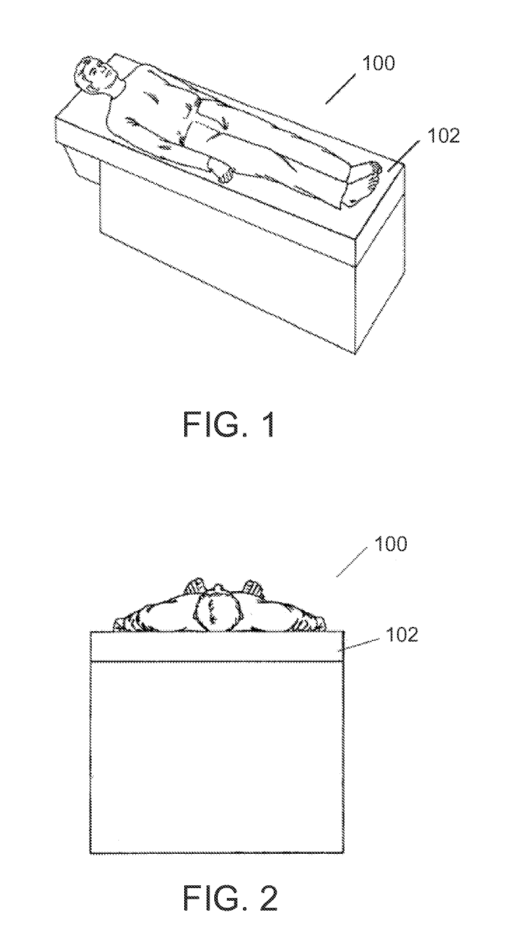

FIG. 1 and FIG. 2 show implementations of the heating tabletop of the present invention. As shown in FIGS. 1 and 2, the heating tabletop 100 comprises a tabletop surface 102. During ray diagnosis, a patient usually lies on the tabletop surface 102.

In FIGS. 1 and 2, the tabletop surface 102 is shown to be rectangular. However, it is readily understood by those skilled in the art that the shape of the tabletop surface is not limited to a rectangular shape, it can be any appropriate shape, such as an elliptical shape or the like.

The term “heating tabletop” is used to represent a tabletop having a heating function in the Description. Besides, the terms “heating tabletop surface” and “tabletop surface” and the like are also used to represent the surface of the “heating tabletop” in the description. Besides, the connotation of the term “tabletop” is not limited to a tabletop that has a fixed surface and is parallel to the ground (as shown in the figures) in general. In one implementation of the present invention, the surface of a heating tabletop can be at any angle with the ground and the surface of a heating tabletop can be adjusted automatically in accordance with the height of a patient.

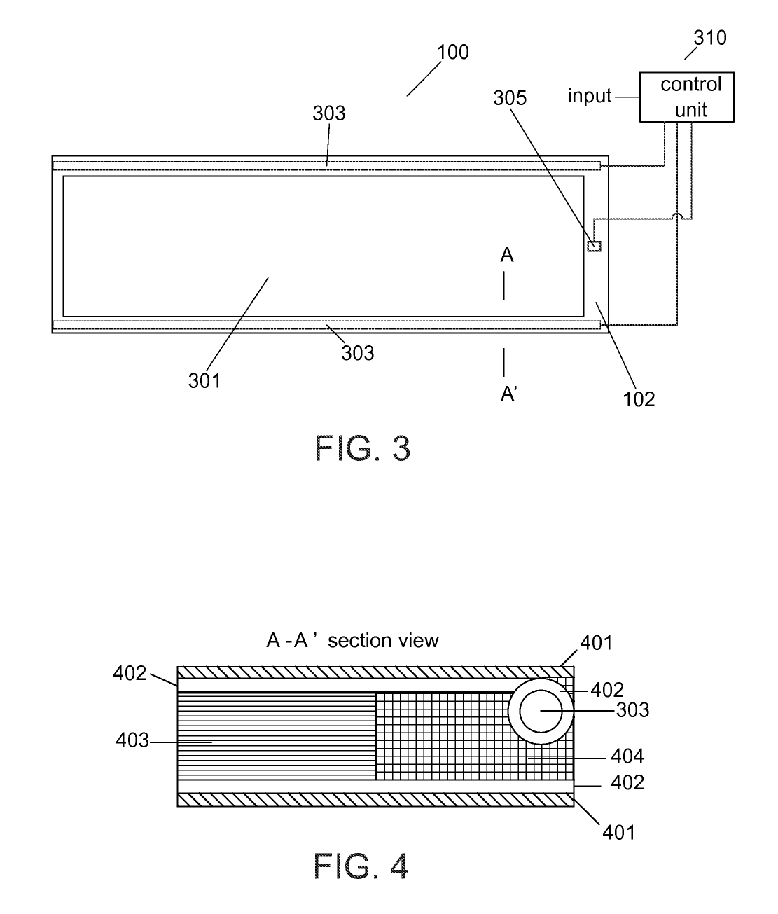

FIG. 3 shows a heating tabletop according to one embodiments of the present invention, wherein, the heating tabletop 100 comprises a tabletop surface 102 and a control unit 310. The tabletop surface 102 further comprises a heating unit 303, an effective imaging area 301 and a temperature feedback unit 305. As shown in FIG. 3, the heating unit is arranged at a longitudinal edge area of the tabletop surface 102 on both sides outside the effective imaging area 301, and the temperature feedback unit 305 is disposed at a lateral edge area of the tabletop surface 102. Further referring to FIG. 3, the control unit 310 has an input terminal for facilitating a medical staff or a patient to give an instruction to the control unit in accordance with the actual conditions. The control unit is further connected with the heating unit 303 and the temperature feedback unit 305.

Although FIG. 3 shows the control unit 310 being connected with the heating unit 303 and the temperature feedback unit 305 in real lines, it should be understood that “connected” herein includes “wired connection” and “wireless connection”. That is to say, the control unit 301 can communicate with the heating unit 303 and temperature feedback unit 305 by using the existing various wireless technologies. Said wireless technologies include but are not limited to: Bluetooth, WLAN (Wireless Local Area Network) and WiFi (Wireless Fidelity), etc.

FIG. 4 shows section view of a heating tabletop according to one embodiment of the present invention taken along the A-A′ direction in FIG. 3, wherein, tabletop surface 102 comprises HPL (High Pressure Laminate) layer 401, carbon fiber composite material layer 402, heating unit 303, foam material layer 403 and fabroil layer 404.

As shown in FIG. 4, two HPL layers 401 are set as the outmost layers, two carbon fiber composite material layers 402 are disposed between the two HPL layers 401. A foam material layer 403 and a fabroil layer 404 in contact with each other are disposed between the two carbon fiber composite material layers 402. The heating unit 303 is enclosed in the upper carbon fiber composite material layer 402. From FIG. 4 it can be seen that the section shape of the heating unit 302 is round, while the upper carbon fiber composite material layer of the two carbon fiber composite material layers 402 completely encloses the heating unit 303.

Now referring to FIGS. 3 and 4, in one embodiment, a heating tabletop 100 used for ray diagnosis comprises a tabletop surface 102. The tabletop surface 101 further comprises a heating unit 303 disposed at a longitudinal edge area of the tabletop surface 102. Said tabletop surface 102 further comprises a carbon fiber composite material layer 402, wherein said heating unit 303 is coupled to said carbon fiber composite material layer 402.

Those skilled in the art can easily understand that the above-described heating tabletop can be used in various ray diagnosis applications. For example, in one implementation, the heating tabletop is used for X-ray diagnosis, while in another implementation, the heating tabletop is used for CT scanning diagnosis.

The heating unit 303 can be a metal resistance wire in one implementation. A large amount of heat is generated in a metal resistance wire when the metal resistance wire is powered. Those skilled in the art can understand that the heating unit is not limited to a metal resistance wire. It can be any product having a heating function.

A metal resistance wire has very strong absorption to X-ray, thus, in one implementation of the present invention, the heating unit is disposed at a longitudinal edge area of the tabletop surface. The “longitudinal edge” herein can be understood as the edge of the long side of the tabletop. In a particular embodiment, the heating unit is positioned with a vertical distance of 3 cm from the long side of the tabletop surface. Preferably, the heating unit is positioned at a vertical distance less than 1 cm from the long side of the tabletop surface.

The term “carbon fiber composite material layer” is used throughout the Description of the present invention to represent a layer formed by a carbon fiber composite material. Similarly, those skilled in the art can easily understand that the terms “foam material layer” and “fabroil layer” mentioned in the following description represent a layer formed by a foam material and a layer formed by fabroil respectively.

In an implementation, the thermal conductivity of the carbon fiber composite material layer 402 is 0.37-0.51 W·m⁻¹·k⁻¹ (watt per meter per Kelvin), which is similar as water. Thus, the carbon fiber composite material layer is good conductor of heat. Besides, most X-rays can pass through a carbon fiber composite material layer without being absorbed. In another particular implementation, the X-ray can be set to have a particular frequency or a frequency within a particular range such that the X-ray can pass through the carbon fiber composite material layer without any obstacle.

The heat generated by the heating unit can be conducted to the whole tabletop surface via the carbon fiber composite material layer by coupling the heating unit 303 to the carbon fiber composite material layer 402, and the heat is thus evenly distributed and the comfort level of a patient lying on the heating tabletop can thus be enhanced. The term “couple” herein means being in direct contact or in indirect contact. For example, in an implementation, the carbon fiber composite material layer 402 can enclose the heating unit 303 directly; while in another implementation, the heating unit 303 can conduct the heat to the carbon fiber composite material layer indirectly via other material layer.

In one implementation, the tabletop surface 102 includes two carbon fiber composite material layers. Arranging two carbon fiber composite material layers can ensure the overall intensity of the tabletop and smaller deformation of the tabletop surface under pressure.

In another implementation, the heating unit 303 is disposed between two carbon fiber composite material layers 402. It should be understood that the heating unit 303 can be at any position between the two carbon fiber composite material layers 402, and is not necessarily in direct contact with the two carbon fiber composite material layers 402. That is to say, other material layers can be disposed between the carbon fiber composite material layers. For example, in an implementation, A foam material layer 403 and a fabroil layer 404 are disposed between the two carbon fiber composite material layers 402.

In an implementation, one of the two carbon fiber composite material layers 402 completely encloses the heating unit 303. As shown in FIG. 4, the upper carbon fiber composite material layer encloses the heating unit 303. In this way heat can be conducted to the surface of the tabletop faster. Furthermore, the heating unit 303 is disposed in the fabroil layer 404. In this case, even electric leakage is present in the heating unit 303, the fabroil layer 404 has a good insulating function and the safety of the heating tabletop is thus enhanced.

In an implementation, the tabletop surface 102 further includes two HPL layers 401. Said two HPL layers 401 are disposed outside the two carbon fiber composite material layers 402 respectively. The two HPL layers 401 plays the role of a protective layer due to its higher rigidity and better impermeability.

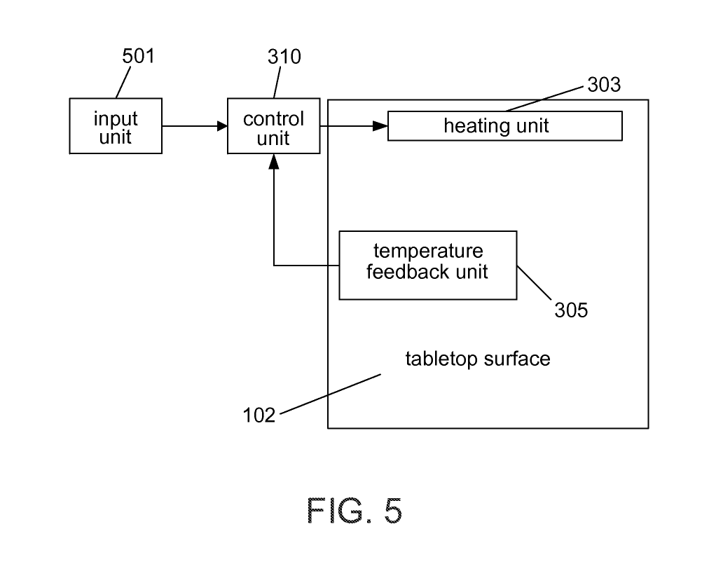

FIG. 5 shows a heating tabletop having temperature loop control according to one embodiment of the present invention. In FIG. 5, the heating tabletop further comprises an input unit 501, a temperature feedback unit 315 and a control unit 310 apart from a tabletop surface 102 and a heating unit 303. Wherein, the input unit 501 provides a temperature setting of the tabletop surface to the control unit 301; the temperature feedback unit 315 is disposed on the tabletop surface 102 for sensing the actual temperature of the tabletop surface and feeds the actual temperature of the tabletop surface to the control unit 310; the control unit 310 controls the time for heating the heating unit 303 through comparing the temperature setting of the tabletop surface provided by the input unit 501 with the actual temperature of the tabletop surface fed back by the temperature feedback unit 315.

In an implementation, a medical staff or a patient can perform input to the input unit 501. It is understood by those skilled in the art that the input unit 501 may operates normally without receiving any external input. For example, the input unit 501 may include a memory with a series of preset parameter values or control values stored therein.

In an implementation, the temperature feedback unit 315 is a temperature feedback sensor. In the present invention, the temperature feedback sensor can be any appropriate type. For example, the temperature feedback sensor can be a contact temperature sensor or a non-contact temperature sensor (i.e. the sensitive element of the temperature sensor is not in contact with the object of test). And for example, the temperature feedback sensor can be an analog temperature sensor (such as a thermocouple or a thermistor, etc.), or a digital temperature sensor.

Furthermore, the temperature feedback unit 315 can be disposed at a lateral edge area of the tabletop surface 102. The term “lateral edge” herein can be understood as the edge of the short side of the tabletop. In a specific embodiment, the temperature feedback unit 315 is disposed at a vertical distance of 3 cm from the short side of the tabletop surface. Preferably, the temperature feedback unit 315 is disposed at a vertical distance less than 1 cm from the short side of the tabletop surface.

The temperature feedback unit 315 may include one or more temperature feedback sensors. In one implementation, the temperature feedback unit 315 includes two temperature feedback sensors disposed adjacent to each other. The expression “two temperature feedback sensors disposed adjacent to each other” herein means the two temperature feedback sensors are spatially close to each other. Thus, in normal cases, the temperatures fed back by the two temperature feedback sensors should be roughly the same. When one of the two temperature feedback sensors fails, the difference between the temperatures fed back by the two temperature feedback sensors should become larger. Thus, it can be determined easily whether a failure occurs to the temperature feedback unit by disposing two temperature feedback sensors adjacent to each other.

Furthermore, in an implementation, the control unit 310 is configured to compare the temperatures fed back by the two temperature feedback sensors. When the difference between the temperatures fed back by the two temperature feedback sensors exceeds a threshold value, said control unit controls the heating unit 303 to heat in a fixed heating period. The fixed heating period can be Heating On for 20 minutes and Heating Off for 10 minutes and the circle is repeated. Of course, those skilled in the art may consider adopting other fixed heating periods to avoid overheating and enhance the safety of the heating tabletop.

Although both the control unit 310 and the input unit 501 as shown beyond the tabletop surface 102 in FIG. 5, those skilled in the art can easily conceive integrating the control unit 310 and/or the input unit 501 within the tabletop surface 102. The control unit 310 and the input unit 501 can be implemented by using hardware, software or a combination thereof. In an implementation, the control unit 310 and the input unit 501 may exist in the form of software codes.

The aforementioned elements of heating unit and temperature feedback unit in the heating tabletop are all products that can be easily bought in the market and the price thereof is relatively low. Besides, the heating tabletop of the present invention can be easily integrated into the current or future medical systems, particularly medical systems for ray diagnosis.

In summary, the heating tabletop proposed in the present invention provides a tabletop with a heating function by adding a heating unit disposed at a longitudinal edge of the tabletop surface, and the imaging quality is not affected. Moreover, heat can be evenly distributed over the whole tabletop surface by disposing a carbon fiber composite material layer within the tabletop surface and coupling the carbon fiber composite material layer with the heating unit, whereby the comfort level of a patient lying on the heating tabletop can be enhanced.

The present invention is disclosed with preferred embodiments as above, but the present invention is not limited thereto. It should be understood that any modification, equivalent substitution or improvement within the spirit and principle of the present invention shall be included in the scope of protection of the present invention. Therefore, the scope of protection of the present invention shall be defined by the claims.

1. A heating tabletop configured to perform ray diagnosis, said heating tabletop comprising:
a tabletop surface comprising at least one carbon fiber composite material layer; and
a heating unit disposed at a longitudinal edge area of the tabletop surface and coupled to said at least one carbon fiber composite material layer.

2. The heating tabletop according to claim 1, wherein said tabletop surface comprises two carbon fiber composite material layers.

3. The heating tabletop according to claim 2, wherein said heating unit is disposed between the two carbon fiber composite material layers (402).

4. The heating tabletop according to claim 2, wherein a first layer of the two carbon fiber composite material layers completely encloses said heating unit.

5. The heating tabletop according to claim 2, further comprises a foam material layer and a fabroil layer disposed between the two carbon fiber composite material layers.

6. The heating tabletop according to claim 5, wherein said heating unit is disposed in said fabroil layer.

7. The heating tabletop according to claim 2, wherein said tabletop surface further comprises two high pressure laminate (HPL) layers disposed outside said two carbon fiber composite material layers, respectively.

8. The heating tabletop according to claim 1, wherein said heating tabletop is configured to be used in X-ray diagnosis.

9. The heating tabletop according to claim 1, wherein said heating tabletop is configured to be used in CT scanning diagnosis.

10. The heating tabletop according to claim 1, further comprising:
a control unit;
an input unit configured to provide a temperature setting of the tabletop surface to the control unit; and
a temperature feedback unit disposed on said tabletop surface and configured to sense an actual temperature of the tabletop surface and to feed back the actual temperature of the tabletop surface to the control unit, wherein the control unit is configured to control a time for heating the heating unit by comparing the temperature setting of the tabletop surface provided by the input unit with the actual temperature of the tabletop surface fed back by the temperature feedback unit.

11. The heating tabletop according to claim 10, wherein said temperature feedback unit is disposed at a lateral edge area of said tabletop surface.

12. The heating tabletop according to claim 10, wherein said temperature feedback unit comprises two temperature feedback sensors disposed adjacent to each other.

13. The heating tabletop according to claim 12, wherein said control unit is further configured to compare temperatures fed back by said two temperature feedback sensors, and to control the heating unit (303) to heat in a fixed heating period when the difference between the temperatures fed back by said two temperature feedback sensors exceed a threshold value.

14. The heating tabletop according to claim 13, wherein said fixed heating period is Heating On 20 minutes and Heating Off 10 minutes.

15. A method for heating a tabletop for ray diagnosis, the tabletop including a tabletop surface, said method comprising:
disposing a heating unit and at least one carbon fiber composite material layer in the tabletop surface, wherein the heating unit is disposed at a longitudinal edge area of the tabletop surface; and
coupling the heating unit to the at least one carbon fiber composite material layer.

16. The method according to claim 15, further comprising:
disposing an input unit, a temperature feedback unit, and a control unit in the tabletop; and
controlling a time for heating the heating unit by comparing the temperature setting of the tabletop surface provided by the input unit with an actual temperature of the tabletop surface fed back by the temperature feedback unit using the control unit.

17. The method according to claim 16, wherein disposing the temperature feedback unit further comprises disposing the temperature feedback unit at a lateral edge area of the tabletop surface.

18. The method according to claim 16, wherein disposing the temperature feedback unit further comprises disposing two temperature feedback sensors adjacent to each other.

19. The method according to claim 18, further comprising:
comparing temperatures fed back by the two temperature feedback sensors; and
controlling the heating unit (303) to heat in a fixed heating period when the difference between the temperatures fed back by the two temperature feedback sensors exceed a threshold value.

20. A medical system including a heating tabletop according to claim 1.
